(19) United States
(12) Patent Application Publication
(10) Pub. No.: US 2007/0265928 A1
(43) Pub. Date: Nov. 15, 2007

(54) Credit rating checking in sales order processing

(76) Inventors: Carsten Fuchs, Wiesloch (DE); Horst Juettner, Mannheim (DE); Martin Semmler, Angelbachtal (DE)

Correspondence Address: FISH & RICHARDSON, P.C., PO BOX 1022, MINNEAPOLIS, MN, 55440-1022, US

(21) Appl. No.: 11/387,155

(22) Filed: Mar. 23, 2006

(51) Int. Cl. G06Q 30/00

(52) U.S. Cl. 705/26

(57) ABSTRACT

This disclosure relates to the use of credit rating information in the processing of an electronic sales order. In one aspect, a computer-implemented method of processing an electronic sales order process includes receiving, in an electronic sales order process, information that identifies an entity liable for making payment for the sales order and for which a database record exists in an accessible database of entities. The method also includes accessing a determined credit rating measure associated with the database record for the entity liable for making payment, to identify a subsequent sales order processing step that has been associated with the determined credit rating measure. The method further includes performing the identified subsequent processing step.

### TECHNICAL FIELD

This disclosure relates to using credit rating measures in the processing of electronic sales orders.

### BACKGROUND

Electronic sales order processing systems often include what is sometimes referred to as dynamic credit checking. Generally, dynamic credit checking involves a check that is made when a sales order is being processed to determine if a credit limit defined for a customer attempting to make a purchase would be exceeded if the purchase were approved. In some basic systems, if the limit is exceeded, the purchase may be denied. This is often the case, for example, with credit card purchases. Alternatively, the failure of the credit checking process may be noted within the electronic sales order so that a credit analyst may review the situation and if appropriate, approve the sales order.

Dynamic credit checking processes may also be quite sophisticated, and may involve various rules and percentages that may be configured to define a credit limit for a customer. In such systems, the complexity is designed to achieve flexibility in dealing with various different credit situations that may be presented. On the other hand, the complexity of such systems may also be a drawback. In some cases, a customer who would be considered a very good credit risk may be subjected to unnecessary procedures that may be appropriate for customers that are not a good credit risk but not for customers that a good credit risk.

Credit ratings, such as those provided by services such as Dunn & Bradstreet, similarly provide valuable information about the likelihood of a customer to pay for sales orders made on credit. Credit ratings may be available from various different services both for individuals and for companies or other organizations. Typically, the credit rating may use multiple qualitative measures of the credit rating, such as excellent, good, fair and poor. Different sources may also use credit rating measures.

### SUMMARY

Generally, this disclosure relates to the use of credit rating information in the processing of an electronic sales order. In one aspect, a computer-implemented method of processing an electronic sales order process is provided. The method includes receiving, in an electronic sales order process, information that identifies an entity liable for making payment for the sales order and for which a database record exists in an accessible database of entities. The method also includes accessing a determined credit rating measure associated with the database record for the entity liable for making payment, to identify a subsequent sales order processing step that has been associated with the determined credit rating measure. The method further includes performing the identified subsequent processing step.

In various implementations, the method of processing an electronic sales order process may include one or more of the following features. The database record for the entity may have an assigned profile that defines a valuation procedure to be used in determining the credit rating measure. The assigned profile may also define multiple different credit rating measures that are determinable, and the determined credit rating measure may be one of the multiple different credit rating measures.

The subsequent processing step may be any possible processing step that makes sense in view of the credit rating for the entity liable for payment. For example, the subsequent processing step may be a user notification of uncreditworthiness. Also, the subsequent processing step may be a step intended to receive additional assurance that the entity will make payment. The identified subsequent processing step may also be performing a so-called dynamic credit check, or in other words, a process that determines whether executing the sales order would exceed a limit in credit balance defined for the entity. In addition, the determined credit rating measure may have an associated status flag that initiates the identified subsequent processing step to be performed. The credit rating measure may be determined during the course of the sales order process, and in addition or alternatively, may be determined before receipt of the electronic sales order process.

In another aspect, a computer program product is provided that includes executable program instructions that, when executed by a processor, cause operations to be performed in accordance with the above-described methods. The computer program product is tangibly embodied in an information carrier, for example, program memory or random access memory.

In yet another aspect, an electronic sales order processing system is provided. The sales order processing system includes a sales order processing module that receives electronic sales orders that each identify an entity liable for making payment for the sales order. The system also includes a database of records for entities identified in electronic sales orders, each entity record having an attribute that defines a determined one of multiple credit rating measures for the entity and having at least one defined subsequent processing step associated with at least one of the multiple credit rating measures. The system also includes a credit rating check module that accesses the attribute that defines the one of multiple credit measures determined for the entity to determine subsequent processing performed by the sales order processing module.

The database of entities may use entity profiles that defines a valuation procedure to be used in determining a credit rating measure. The profiles may be assignable to entity records so that an entity record has an assigned profile. In addition, the system may include components that perform the methods described previously and in the following detailed description.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary computing system in which sales order credit rating checking techniques are employed.

FIG. 2 is a data model of an exemplary business partner record that may be used in the system shown in FIG. 1.

FIG. 3 is a flow chart of an example configuration method that may be used in a sales order credit rating checking method.

FIG. 4 is a flow chart of an example run-time method that may be used in a sales order credit rating checking method.

FIG. 5A-5C are a series of display device screen snapshots that show an example ratings definition process that may be used in a sales order credit ratings check method.

FIG. 6 is a schematic diagram of a computer system that may be used to execute the disclosed computer-implemented methods.

Like reference symbols in the various drawings indicate like elements.

### DETAILED DESCRIPTION

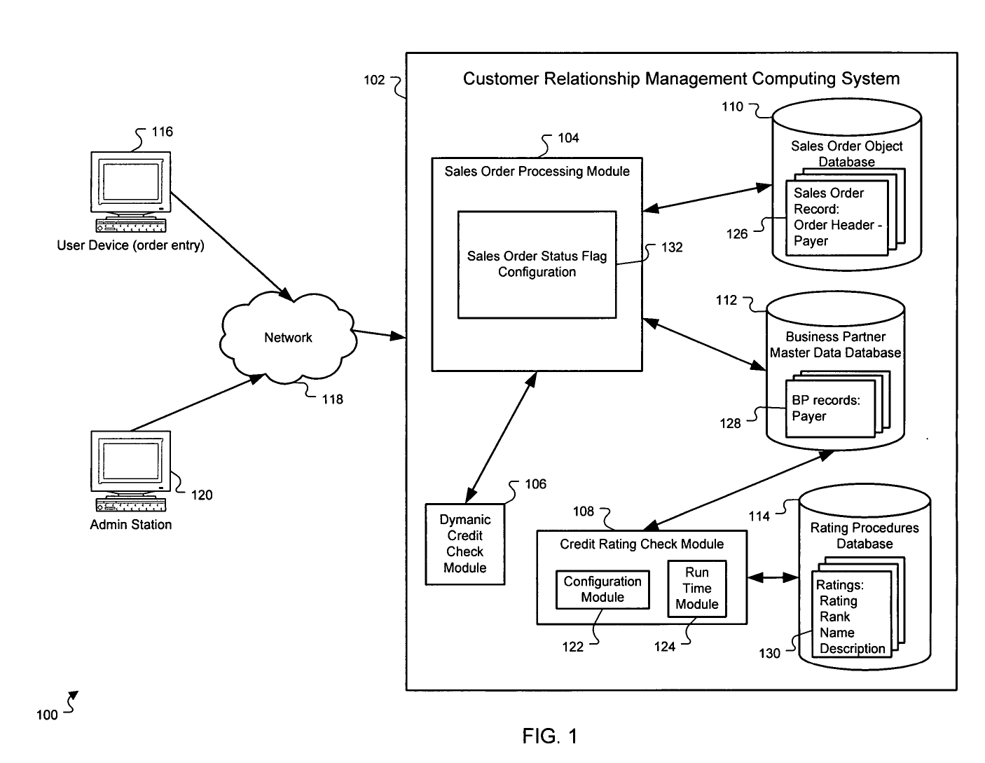

FIG. 1 is an example of a customer relationship management (CRM) computing system 100 system. Generally, a CRM computing system 100 performs functions that manage a company's interaction with customers, which may include sales functions, marketing functions and service functions, for example. For present purposes, it is sufficient to understand that the CRM computing system 100 is one in which customer sales orders are generated and processed.

In the FIG. 1 example, the system 100 includes server-side equipment 102 that includes a sales order processing module 104, a dynamic credit check module 106, and a credit rating check (CRC) module 108. The server-side equipment 102 also includes repositories containing database records which contain information needed by a credit rating check process. In the example of FIG. 1, the repositories include a sales order object database 110, a business partner (BP) master data database 112, and a rating procedures database 114. The example CRM computing system 100 of FIG. 1 also includes a user device 116 which would allow a sales agent, for example, to enter a sales order into the server-side equipment 102 by way of a network 118. Also included in the FIG. 1 example is an administrator station 120 which could be used by a system administrator, for example, to configure the rules for the credit rating check process for a particular business partner by way of the network 118.

The CRM computing system 100 may be configured to execute a sales order entry process, either entirely within the CRM computing system 100 or upon receipt of external electronic information. To do so, the server-side equipment 102 includes an order entry module 104. In one example, an automobile company may use the CRM computing system 100. In such an example, a sales order may be received by the server-side equipment 102, and specifically the sales order processing module 104. The orders may come from authorized dealers or from other automobile service companies, for example. In many cases, but not in all cases, the sales orders may be received from a dealer over a business-to-business connection to the CRM computing system 100 (though not shown in FIG. 1). In such a case, a user in a dealer organization may be responsible for entering information into a sales order document at a client computer device of the dealer's computing system. The CRM computing system 100 typically includes client devices for users, and in the FIG. 1 example, one such device, user device 116, is shown for simplicity. The user device 116 may be a desktop computer or a mobile computing system such as a laptop, for example. As an alternative to the business-to-business sales order process described above, sales orders may be entered using the user device 116, by a sales agent, for example, who is taking an order from a customer.

The CRM computing system 100 of FIG. 1 is also configured to perform a credit rating check process that determines a customer-specific action to be taken within a sales order process depending upon the customer's creditworthiness. In addition, the CRM computing system 100 is configured to execute configuration processes to configure how a credit rating check process is to be conducted during run-time operation of the system when sales orders are received. Such a credit rating check process may be performed before execution of a confirmation, delivery, or some other logistics process involved in fulfilling the order. As such, if it is determined that a customer's creditworthiness is in question, certain specified processing steps may be taken in connection with the sales order processing.

The credit rating check (CRC) module 108 includes a configuration module 122 and a run-time module 124. Both will be described in more detail later, but for present purposes, the configuration module 122 performs the processes that allow an administrator to configure how the credit rating checking is to be performed during run-time processing of an electronic sales order, and the run-time module 124 performs the credit rating checking on a particular sales order during run-time. Both modules may utilize or call other components of the CRM computing system 100 during processing.

The CRM computing system 100 includes repositories that provide data to the credit rating check process. The sales order object database 110 includes sales order records 126 that may contain information required to execute a sales order, such as an identification of payer (a business partner) for the sales order, products requested, delivery address, and when and how delivery is requested. The business partner (BP) master data database 112 includes BP records 128 which contain information about business partners (for example, possible payers), such as information like address, contact persons, and various preferences. In the example of FIG. 1, the BP records 128 also contain an assigned profile for a credit rating check which defines the conditions to be used for the check and the actions to be taken as a result of the check.

The rating procedures database 114 includes multiple different credit rating records 130. One of the credit rating records 130 may then be selectively assigned to a credit rating check profile that is created for a particular business partner record, as will be described in more detail later. Each rating record includes a rating procedures definition that includes a rating scheme that is used to determine a customer's credit rating. For example, the rating scheme may be a proprietary rating scheme designed by an individual company, for example, the same company that uses the credit rating check methods described in this document. In another example, the rating scheme may be a third-party rating scheme provided by a credit information vendor, where rating information about a particular business partner entity may be accessed over network connections. One such third-party credit rating scheme is Dun & Bradstreet.

The rating scheme is associated with a ratings procedure which is then included in the ratings records 130. The credit rating procedure may also include the ratings, for example, “A” or “B”, which will result when the rating scheme is applied to a particular customer. The rating record 130 may also contain a rank, for example a number, for each of the ratings, as well as a name and description of each rating, as will be describe in more detail later by way of example.

Briefly, the processing of sales orders and the processing of a run-time credit rating check on the customer placing the sales order may operate in the FIG. 1 system as follows. Sales orders are received in, or by, the sales order processing module 104 of the CRM computing system 100. The sales order processing module 104 creates a sales order record 126 for the customer placing the order. The CRC module 108 then may be called to perform a credit ratings check on the customer placing the order (or more specifically, the payer for the order) and determine the payer's creditworthiness, which may be linked to a status flag or other indicator within the sales order record. A sales order status flag configuration 132 may be used to enable or disable any actions to be taken within the sales order process as a result of the credit rating check. The credit rating check process may also take into account the type of transaction being performed in the sales order and also the total cost of the products ordered. The result of the credit rating check may, for example, determine if a dynamic credit check is to be performed on the customer for the sales order by the dynamic credit check module 106 before the order is confirmed. Once all credit checks are complete and the sales order has been confirmed, another computing system module (not shown in FIG. 1) may process the sales order object, for example by requesting the manufacture and delivery of products requested in the sales order.

In more detail, the CRC module 108 may perform its credit rating check by determining the creditworthiness of the payer for the sales order (which may be referred to as a business partner). For example, suppose a sales order for customer Adam is generated. A sales agent, for example, may enter the sales order by means of user device 116. During the processing of the sales order in the sales order processing module 104, a credit rating check may be performed by the run-time module 124 of the CRC module 108 for customer Adam using a rating procedure specified in the BP record 128 for customer Adam and as that rating procedure is defined in the ratings record 130 in the rating procedure database 114. The result of the credit rating check may be stored along with past results in the BP record 128 for customer Adam. For example, it may be determined by the credit rating check that Adam has an “A” credit rating and this credit rating is valid for the time period during which the sales order has been placed.

The ratings record 130 for the rating procedure specified in the BP record 128 for a customer may define actions to be taken by the sales order processing module 104 with regard to the credit rating for the customer. In this example, a credit rating of “A” may result in customer Adam having unlimited credit and no further credit checks are deemed necessary. The sales order status flag configuration 132 may be set to enable actions to be taken within the sales order process that depend on the results of the credit rating check. Based on Adam's credit rating, the sales agent may continue to process, confirm and place the order. The sales order record 126 that is created for the sales order may be stored in the sales order object database 110 for further processing. Further processing may involve, for example, manufacturing preparing for the production of the products ordered or, in another example, inventory control locating and procuring the products ordered.

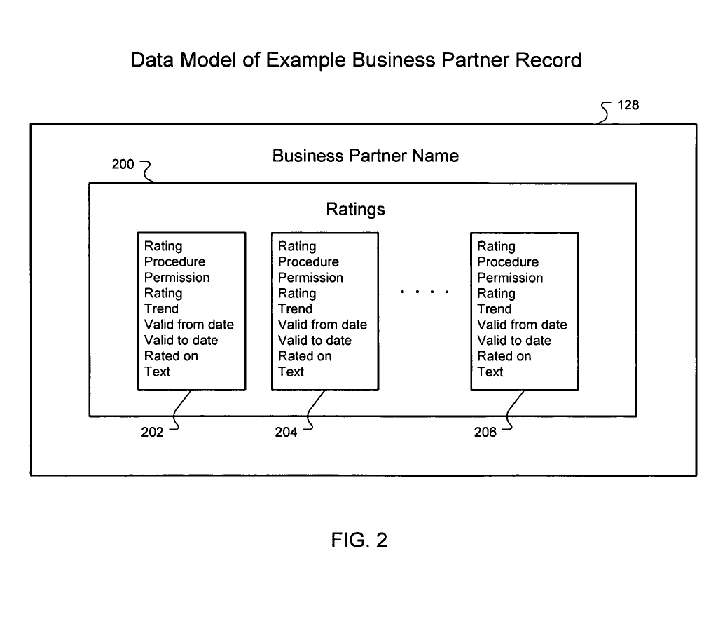

FIG. 2 is an exemplary data model of a business partner record as shown in FIG. 1. The BP record 128 in this example is stored in the business partner master data database 112 based on the business partner name. Although a typical BP record will include more information such as address and other information about the business partner, FIG. 2 focuses on the aspects of a BP record that pertains to credit rating checking. The BP record 128 may contain one or more ratings 200 that have been determined for the business partner. Each ratings data 202, 204, and 206 contains information about the creditworthiness of the business partner at a certain point in time. The ratings data 202, 204, and 206 may be generated when a credit rating check is performed on the business partner. This can occur, for example, when a sales order is created or changed in the sales order processing module 104 (or when the payer is changed in an order header for the sales order record 126 in the sales order object database 110), and may additionally or alternatively occur when a credit rating check (CRC) profile is defined for a business partner record.

The ratings data 202, for example, may contain the rating procedure used in the credit rating check process. The rating procedure, for example, may be an external rating scheme (i.e. Dun & Bradstreet) or a proprietary scheme. The rating procedure that is used is defined in a ratings record 130 in the rating procedures database 114. Also included in the ratings data 202 is a flag indicating whether or not permission has been given to use the results of this rating procedure for the business partner. The value of this flag may be set, for example, by a sales agent using the user device 116 by way of network 118, when placing a sales order for a customer.

The ratings data 202 may include the rating that resulted from the credit rating check process performed on the business partner at a particular point in time, which can be shown in the ratings data 202 as “rated on”. The rating in the ratings data 202 may also have a validity period, which can be defined as a “valid from date” and a “valid to date”. Also included with the ratings data 202 may be trend information, for example, indicating if this rating is part of a positive or negative trend for the customer. The ratings data 202 may include a text entry that, for example, provides additional information about the credit rating check process performed to produce the rating for the business partner.

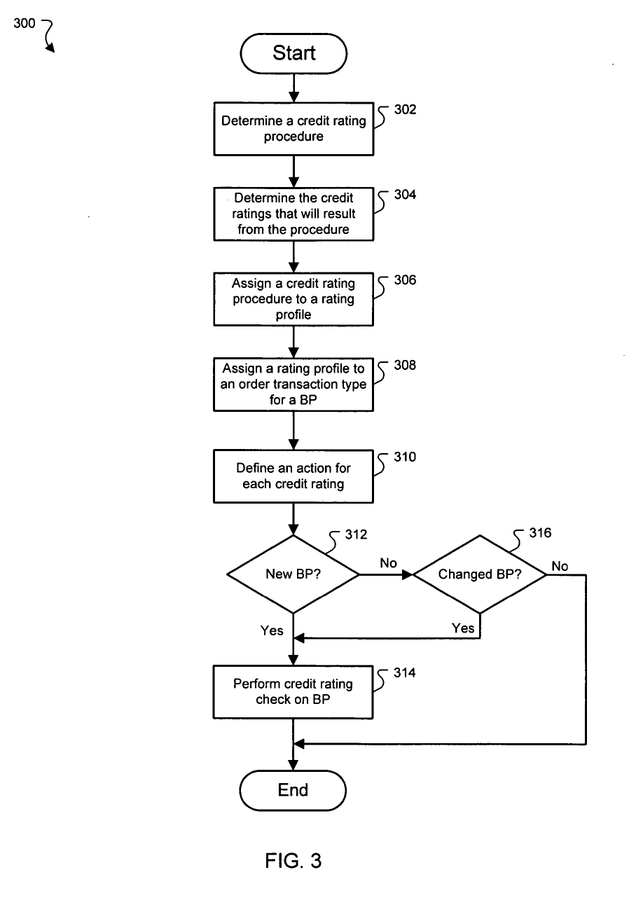

FIG. 3 shows a flow chart that depicts exemplary steps for configuring how the credit rating check method will be performed during a run-time sales order process. FIG. 3 shows the steps for an example configuration process in the exemplary computing system of FIG. 1.

In FIG. 3, a processor executing instructions stored in a computer program product can perform a configuration process 300. This can occur, for example, when the CRM computing system 100 is running and an operator, by means of administrator station 120, initiates a particular configuration function. More specifically, FIG. 3 shows the process performed by the configuration module 122 of the CRC module 108. A user may provide information at administrator station 120, which is transmitted to the server-side equipment 102 and acted upon by the configuration module 122.

First, in step 302, a rating scheme is selected, for example Dun & Bradstreet, and a ratings record 130 is created in the rating procedures database 114, as shown in FIG. 1. This step may be performed by the user providing information at administrator station 120, for example, by checking certain boxes or entering data into certain fields by use of, for example, a keyboard. Next, in step 304, the ratings that may result from the ratings procedure to be applied to a customer during a credit rating check are determined and entered into the ratings record 130, along with other information relative to the ratings (such as rankings and descriptions) as described in description of FIG. 1. This information may be entered by the administrator using administrator station 120.

In step 306, a rating profile is created by the administrator. The rating profile is assigned a ratings record 130 from the rating procedure database 114. Next, in step 308, the rating profile is assigned to an order transaction type, for example sales, for a particular business partner. This may be done by the administrator using administrator station 120 to access the applicable BP record in the BP master data database 112, in FIG. 1. This step 308 effectively assigns the rating profile to the business partner. It will be appreciated that a particular business partner may be a payer in a number of different transaction types, and different profiles may be assigned to different transaction types for the same business partner. Now that the rating profile has been assigned to the business partner (and a particular transaction type in which the business partner may engage), step 310 allows the administrator to define an action to be taken for each rating. Each of the ratings may have a different defined action that is taken, as will be described in more detail later by way of example. A rating may be generated from the credit rating check process (which may be referred to as a rate handling specification) using the rating procedure selected from the rating procedure database 114.

Next, step 312 checks if the business partner assigned the rating profile in the sales order header is a new business partner. If yes, the CRM computing system 100 in step 314 may perform a credit rating check process on the new business partner. The results of the check, in the form of ratings data 202 for example as shown in FIG. 2, are stored in the BP record 128 for the business partner. As described in connection with FIG. 2, the ratings data 202 may have a validity period, and so when a transaction occurs later in time for that particular business partner, the ratings data 202 already determined may be used if it is still valid, or the credit rating check process may be performed again and an additional new ratings data with a new validity period determined. After step 314, the configuration process 300 is then ended.

If step 312 determines that the business partner in the sales order header already existed, it may then determines in step 316 if the business partner in the BP record has been changed during the configuration process to another pre-existing business partner. If yes, the CRM computing system 100 in step 314 may perform a credit rating check process on the updated business partner in the BP record. The results of the check, in the form of ratings data 202 for example as shown in FIG. 2, may then be stored in the BP record 128 for the business partner. The configuration process 300 may then ended. If step 316 determines that the business partner was not changed in the BP record, the configuration process 300 may be ended.

The following example further illustrates the credit rating check configuration process by using an example credit rating procedure, which will be given a fictitious name of “SPL_TEST.” Using administrator station 120 shown in FIG. 1, an administrator accesses the server-side equipment 102, and more specifically the configuration module 122 of the credit rating check module 108. The administrator selects a credit rating scheme, as in step 302, and creates a ratings procedure record 130 for the selected credit rating scheme to be placed in the rating procedure database 114. The credit rating procedure is called, in this example, SPL_TEST. Next, in step 304, the administrator determines the credit ratings that will result from the credit rating check process applying the rating scheme on a customer, for example Adam. Example credit ratings may be A, B, E, and X. Associated with the ratings in the ratings record 130 may be a rank, for example, rating A may have a rank of 1, rating B may have a rank of 2, rating E may have a rank of 5 and rating X may have a rank of 3. Also associated with the credit rating may be a name. For example, rating A may be called an “excellent rating”, rating B may be called a “standard rating,” rating C may be called a “stop order” and rating X may be called a “manual check.” Descriptive text for each rating may also be included in the ratings record. As an example, rating A may be described as “no further checks”, while rating E may be described as “order not accepted.” The descriptive text may describe the resultant action that may take place in a sales order based on the customer's credit rating as a result of the credit rating check process. This descriptive text may be displayed, for example, to a sales agent on user device 116 in FIG. 1 when a sales order entry process is being performed.

Step 306 assigns the SPL_TEST rating procedure to a rating profile called SPL1, for example. Next, in step 308, the administrator accesses the BP record for the customer, Adam, in the BP master data database 112. The administrator, for example, may select “sales” as the business transaction type and customize the BP record for the customer, Adam, for this particular business transaction type to enable the credit rating check process to occur. This may be done, for example, by a user selecting a check box on a user interface display. The administrator may then select, for example by means of a tab control, the rating profile to use for the credit rating check process, in this example SPL1.

Next, in step 310, the administrator defines a rate handling specification, as described above, by defining an action to be performed within the sales order for each credit rating defined in the ratings procedure. The action taken within the sales order may be a message displayed to the sales agent during creation of the sales order indicating the creditworthiness of the customer at that time for the particular order being placed. For example, if it is determined that the credit rating for Adam is “A”, a message may be displayed within the sales order stating “Payer Adam unlimited creditworthy; no further checks needed.” As another example, Adam receives a credit rating of “B” which may require a second dynamic credit check to be performed. A message may be displayed in the sales order stating “Payer Adam is limited creditworthy; second credit check to be performed.” The sales agent may then, for example, select a button on the user device 116 of FIG. 1 that would initiate the dynamic credit check.

Step 312 determines if Adam is a new business partner. If yes, Adam will not have any ratings 200, as shown in FIG. 2, so a credit rating check will be performed and ratings data 202 will be added to the BP record 128 for Adam. A credit rating check will also be performed on the customer Adam if, for example, the administrator on the order header for the sales order record 126 changed the customer from a previous customer to Adam. This will be determined in step 316 and, if yes, the credit rating check will be performed and the results will be placed in the ratings 200 of the BP record 128 for Adam. If Adam is not a new business partner and the order header for the sales order record 126 has not been changed, no credit rating check process will be performed and the configuration process will end.

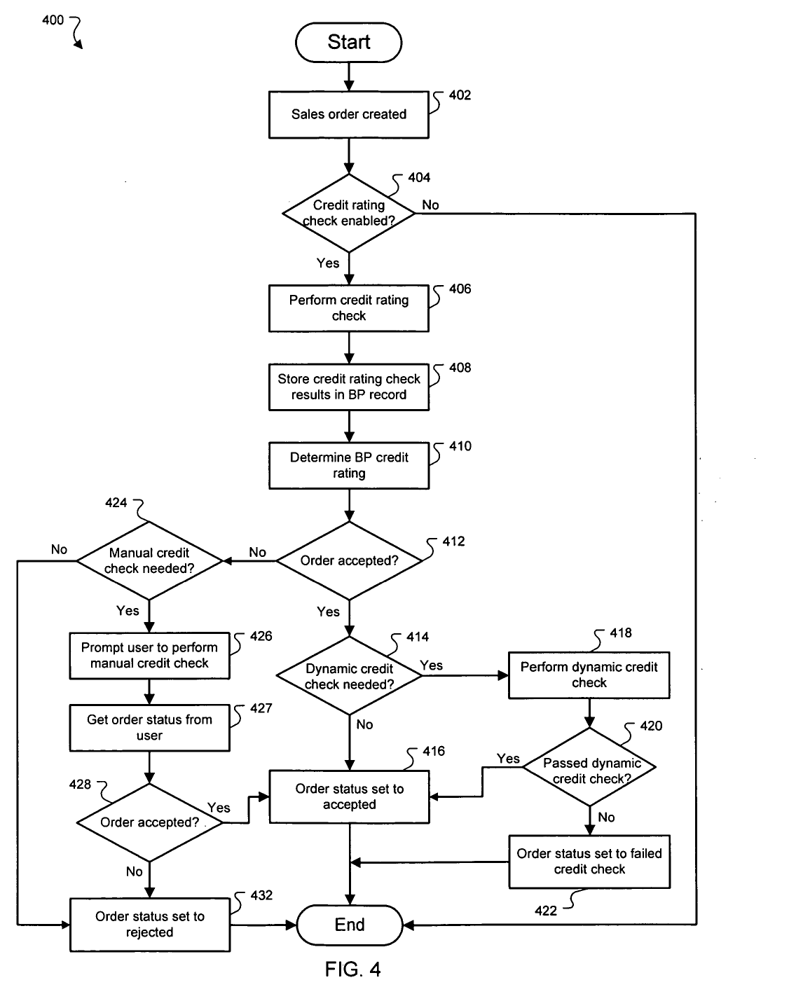

FIG. 4 shows a detailed flow chart that depicts exemplary steps that may be performed within a sales order process that uses the credit rating check method that may be performed in the exemplary computing system of FIG. 1.

In FIG. 4, a processor executing instructions stored in a computer program product can perform a credit rating check process 400. The process can occur, for example, when the CRM computing system 100 is running and a sales agent by means of user device 116 initiates a particular function. More specifically, FIG. 4 shows the process performed by the run-time module 124 of the CRC module 108. A user may provide information at user device 116, which is transmitted to the server-side equipment 102 and acted upon by the run-time module 124.

In step 402, a sales order is placed in the CRM computing system 100 for a customer and a sales order record 126 is created. This may occur by a sales agent, for example, entering into the CRM computing system 100 a customer's sales order by means of user device 116. Alternatively, the CRM computing system 100 may receive electronic information, for example from the customer, which may cause the sales order to be created. The sales order will contain at least one order item (which may be referred to as a product) and may include information such as product identifiers, quantities, customer name, date order was placed, requested delivery date and modes of delivery, ship-to-address, etc.

Step 404 determines if a credit rating check is to be performed on the customer listed in the header of the sales order record 126. The BP record for the customer is examined to see if the credit rating check has been enabled during the configuration process 300 as described in FIG. 3. If it has not been enabled, a credit rating check on the customer will not be performed, the credit rating check process 400 will end and the sales agent will continue with the processing of the sales order.

However, if step 404 determines that a credit rating check is to be performed, step 406 will perform the credit rating check using the rating profile specified in the BP record for the customer. For example, the rating profile for customer Adam indicates that a proprietary rating scheme is to be used to determine Adam's creditworthiness. The rating procedure, using the proprietary rating scheme, for example, examines the BP record 128 for customer Adam and determines that Adam has paid all of his outstanding debts to the company fully and on time within the last three years. This information will be used to determine Adam's credit rating based upon the rating procedure described in FIG. 3. The results of the credit rating check will consist of ratings data, an example of which was shown in FIG. 2. Step 408 will take the ratings data and add it to the ratings 200 for the customer in the BP record 128.

Next, step 410 will determine the credit rating for the customer for the sales order by examining the results of the credit rating check. As described in FIG. 3, the credit rating will have associated with it an action to be taken within the sales order. Step 412, using the credit rating and knowing the action to be taken for the particular credit rating, will determine if the sales order may be accepted. If yes, step 414 will then determine from the credit rating if a dynamic credit check needs to be performed on the customer placing the sales order. The dynamic credit rating check may consist of, for example, determining if the customer exceeds his credit limit. This may be done by adding the total of the current purchase to any other outstanding debts the customer may have with the company and comparing this to a predetermined credit limit. The customer's credit limit may be determined, for example, by accessing a third party system which may be a credit company's computer system. If no and a dynamic credit check need not be performed, the sales order status, in step 416, will be set as accepted, the credit rating check process will end and the sales agent, for example, may continue with the placement of the sales order.

If in step 414, however, the credit rating indicates that a dynamic credit check is to be performed on the customer, step 418 will perform the dynamic credit check. This is done by calling the dynamic credit check module 106, as shown in FIG. 1, and by the dynamic credit check module 106 performing the dynamic credit check. Next, in step 420, it is determined if the customer passed the dynamic credit check and was found creditworthy. If no, step 422 sets the sales order status to reflect that the customer's credit limit has been exceeded and the credit rating check process 400 ends. In such a case, the sales agent may continue with the processing of the sales order, for example, by rejecting the order due to the fact that the customer's credit limit has been exceeded. If the customer passed the dynamic credit check, as determined in step 420, step 416 will set the order status to accepted, the credit rating check process 400 will end and the sales agent, for example, may continue with the placement of the sales order.

If in step 412 the sales order was found unacceptable due to the credit rating of the customer, step 424 determines from the credit rating and the action associated with it if a manual check of the sales order needs to be performed, for example, by the sales agent. If it is determined in step 424 that a manual check of the customer's credit rating is to be performed, a sales agent, for example, will be prompted to perform this check in step 426. The manual check may consist of a sales agent, for example, looking up past credit ratings for a customer by accessing the BP record 128 for the customer by way of user device 116, as shown in FIG. 1. The sales agent may determine from examining the ratings 200 in the BP record 128 for the customer that the sales order can be accepted. Step 427 would be receipt of input from the user performing the manual check. If the sales agent accepts the sales order, step 427 will receive this input and step 428 will determine that the order has been accepted. The sales order status will be set to accepted, in step 416, the credit rating check process 400 will end and the sales agent, for example, may continue with the placement of the sales order. However if the sales agent determines that the customer is not creditworthy, the sales agent will reject the order, step 427 will receive this input and step 428 will determine that the order has been rejected. Step 432 will set the sales order status to rejected, the credit rating check process 400 will end and the sales agent, for example, will not place the sales order notifying the customer of the status.

If in step 412 the sales order was found unacceptable due to the credit rating of the customer and in step 424 it was determined by the credit rating that a manual credit check need not be performed, step 432 will set the sales order status to rejected. The credit rating check process 400 will end and the sales agent, for example, will not place the sales order, notifying the customer of the sales order status.

The following example further illustrates the credit rating check process. In the example discussed previously, a customer Adam places a sales order which includes a variety of automobile spare parts by telephoning an automobile company, for example, Acme Motor Company. He is placed in contact with a sales agent who enters his sales order, as in step 402, into the CRM computing system 100 by means of user device 116, which for this example may be a desktop computer. The sales agent includes in the sales order the customer's name, Adam, the order items, the requested quantity of each order item as well as the current date, the requested receipt date, and other information relative to a sales order. The sales agent indicates that the sales order is complete, for example, through a control on the display device screen of the desktop computer. Once this action occurs, step 404 determines whether or not the credit rating check is enabled for the customer for the sales order. If it is not, as described above, the sales order check process 400 ends and the sales order may be further processed. However, if the credit rating check is enabled, for example as indicated by a check box displayed on the device screen of the desktop computer, a credit rating check is performed in step 406. The procedure used for the credit rating check is included in the rating profile associated with the customer as indicated in the BP record 128 for the customer and configured as described in FIG. 3. In this example, the credit rating for Adam, using Dun & Bradstreet as the rating scheme associated with the rating procedure, is A. Next in step 408, the rating result and the rating procedure are stored in the rating data in the ratings 200 for the BP record 128, as shown in FIG. 2. Other rating data stored may include, but is not limited to, a permission flag, a trend, a validity period (in the form of a to and from date), the date the rating was performed on and text describing the action to be taken as a result of the rating. For this example, it may be determined in step 410 that Adam has been given a credit rating of A on Dec. 29, 2005. The permission flag has been set indicating permission for this credit rating to be used in determining Adam's creditworthiness for the sale order, as described in FIG. 2. It is indicated as a positive trend. Also included is a validity period from Sep. 1, 2005 to Dec. 31, 2005, indicating that this credit rating is valid for this time period. The text to describe the credit rating is “No further checks.”

Step 412, based on Adam's credit rating of A, accepts the order and step 414, based on Adam's credit rating of A determines that no dynamic credit check is needed. This action is associated with the credit rating in the rating profile for the business partner. The order status is accepted, in step 416, and may be indicated to the sales agent, for example, by a text message contained in the sales order header which may be displayed on the display device screen of the desktop computer. At this point, the credit rating check process ends and the sales agent may continue with the sales order process. For example, the sales agent may indicate that the sales order is complete and ready to be placed, for example, through a control on the display device screen of the desktop computer.

In another example, a credit rating check performed on Adam for the sales order may result in an X rating. Step 412 determines that the order cannot be accepted with this credit rating for the customer. Therefore step 424 will need to determine if a manual credit check is needed for the customer. An X rating has a manual credit rating check as the action associated with it. The sales agent is prompted to perform this action in step 426 as described above. As a result of this manual check, the sales agent determines whether or not the sales order should be accepted. If Adam is found to be creditworthy, the sales agent will accept the order and step 427 will receive this input. This may be done, for example, by the sales agent accessing a tab control on the display device of the desktop computer by clicking on it with an input device, for example a mouse, and by accessing the user status entry and manually changing the status, for example, by using the keyboard of the desktop computer for text entry. Step 428 will determine that the order has been accepted and step 430 will set the sales order status to accepted. At this point, the credit rating check process 400 ends and the sales agent may continue with the sales order process. For example, the sales agent may indicate that the sales order is complete and ready to be placed, for example, through a control on the display device screen of the desktop computer.

In another example, Adam's credit rating of X as determined in step 410 results in the sales order not being accepted in step 412 and a manual credit check is indicated in step 424. The sales agent, for example, is prompted to perform the manual credit check in step 424. If Adam, after a manual credit check is performed, is found to be not creditworthy, the sales agent will not accept the sales order and step 427 will receive this input. Step 428 will determine that the order has been rejected and step 432 will set the sales order status to “rejected.” At this point, the credit rating check process 400 ends and the sales agent will not continue with the sales order process. For example, the sales agent may inform Adam by telephone that his order has been rejected due to his credit rating and that his rating has been manually checked and verified by the sales agent.

In another example, step 410 determines Adam's credit rating to be E. The action associated with this rating is to reject the order. Therefore, step 412 does not accept the order, step 424 determines that no manual check is to be performed on the customer and step 432 sets the order status flag to rejected. The credit rating check process 400 ends and the sales agent may, for example, terminate the sales order process and inform the customer of the order status.

Another example finds Adam's credit rating, in step 410, to be B. The action associated with the credit rating in the rating profile associated with the business partner indicates that in step 412 the order cannot be accepted. Step 414 determines for a B rating that a dynamic credit check is to be performed on Adam. Step 418 performs this check by totaling the cost of all order items in the current sales order and adding that number to any outstanding debts Adam may have with the automobile company, in this example, Acme Motor Company. If the total exceeds a predetermined maximum allowable credit limit, which may be determined as described above, the customer does not pass the credit limit check as determined in step 420. The order status is then set to failed credit check in step 422. The credit rating check process 400 ends and the sales agent may, for example, terminate the sales order process and inform the customer of the order status. However, in another example, if Adam's total current debt, consisting of any previous debts and the total of the current sales order, does not exceed his credit limit, step 420 determines that Adam has passed the dynamic credit check and the order status is set to accepted in step 416. The credit rating check process 400 ends and the sales agent may continue with the sales order process.

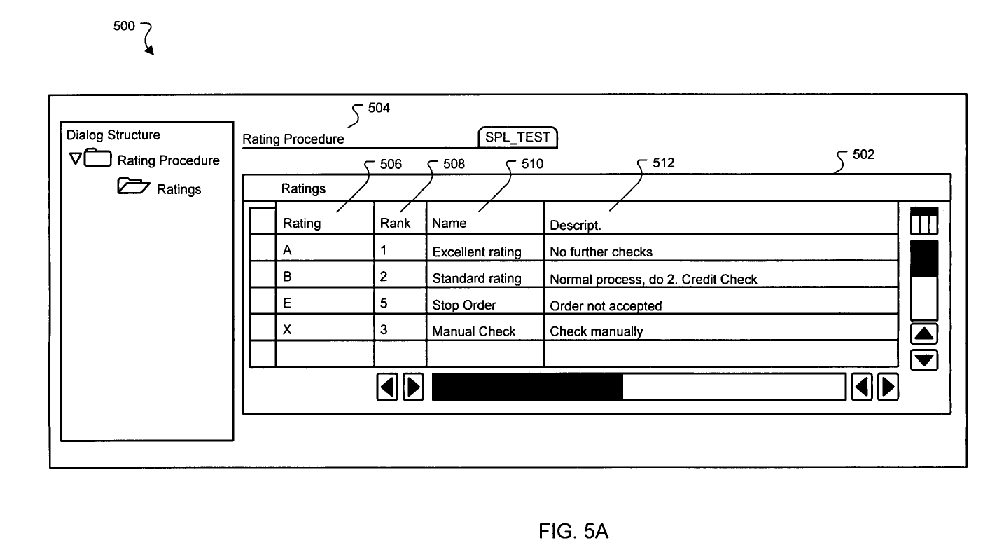

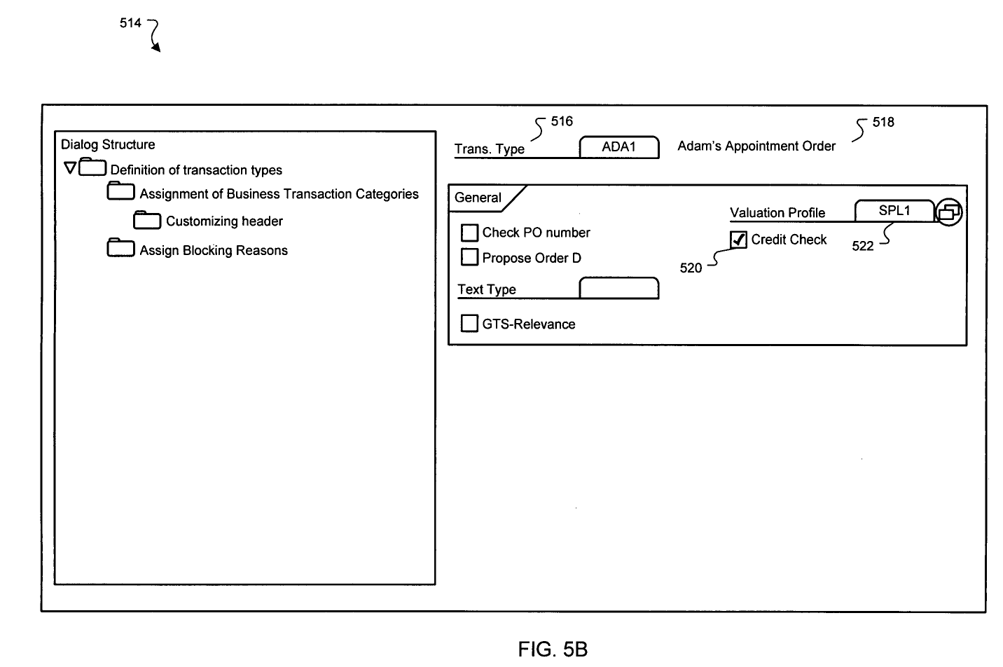

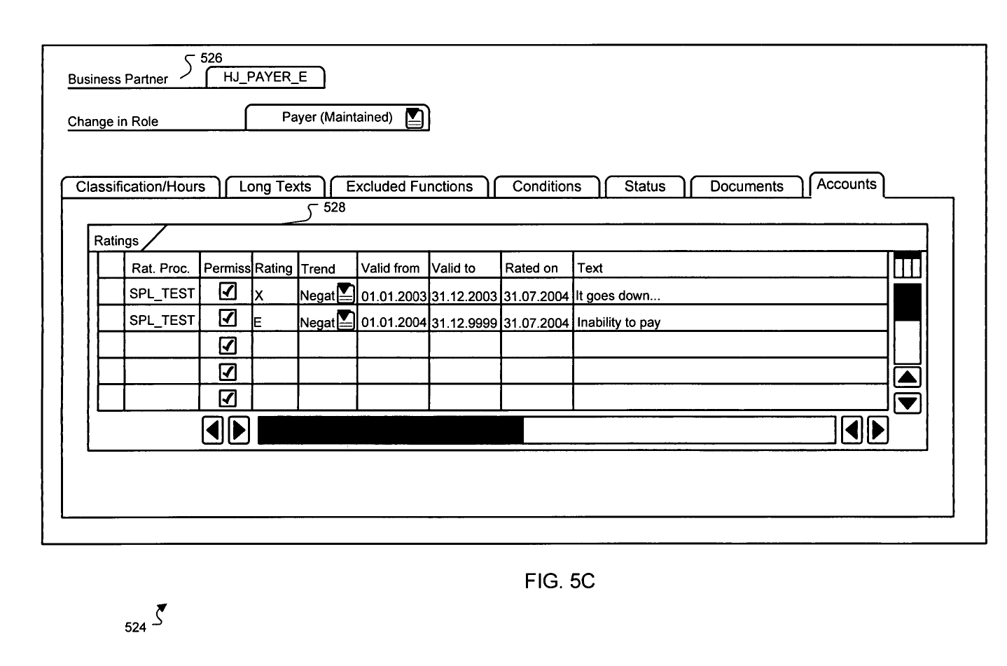

FIGS. 5A, 5B and 5C are example display device screen shots showing the credit rating check configuration process that may be used in the configuration process 300, as shown in FIG. 3. This may be displayed in the administrator station 120 of FIG. 1. FIG. 5A is a screen shot 500 showing a table 502 of an exemplary ratings record contents, as described in FIG. 1. Included is the rating procedure 504 as stored in the rating procedures database 114. The table 502 contains the ratings 506 associated with the ratings procedure 502. Each rating 506 has a rank 508, a name 510 and a description 512 associated with it. The description 512 may contain information about the action to be performed within the sales order as a result of a customer receiving a particular credit rating. This screen, for example, can be used by an administrator who, by using admin station 120, can enter the information in the table 502 for the SPL_TEST ratings procedure.

Screen shot 514, in FIG. 5B, shows an example sales order record 126. In this example, the transaction type 516 is a sales order and the payer is Adam 518. For the payer Adam and sales order transaction type, the credit check box 520 is checked, enabling a credit rating check to be performed on Adam when he places a sales order. The rating profile to be used for the credit rating check 522 for this example is selected to be SPL1. This screen, for example, can be used by an administrator who, by using admin station 120, can enable or disable the credit rating check by means of the credit check box 520 and can enter the rating profile to be used for the credit rating check.

FIG. 5C is a screen shot 524 of example ratings 200 that may be included in the BP record 128 for a business partner 526, in this example HJ_PAYER_E. A table 528 includes, but is not limited to, the ratings data 202 determined by a credit rating check and an example of which is shown in FIG. 2. This screen, for example, can be used by a sales agent who, by using user device 116, can access the ratings data for a business partner if the credit rating check process, for example, results in a rating for the customer requiring a manual credit rating check to be performed by the sales agent.

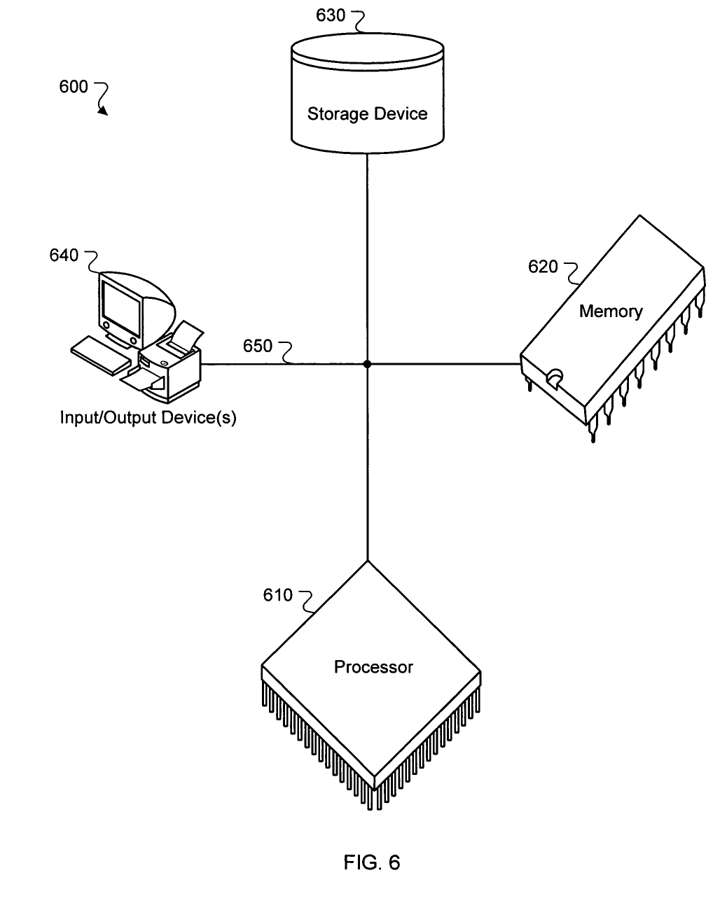

FIG. 6 is a schematic diagram of a generic computer system 600. The system 600 can be used for the operations described in association with the configuration process 300 according to one implementation. For example, the system 600 may be included in either or all of the CRM computing system 100, the user devices 11 and the admin station 120.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

Also, the logic flows depicted in the figures do not require the particular order shown, or sequential order, to achieve desirable results. Also, other steps may be provided, or steps may be eliminated, from the described flows, and other components may be added to, or removed from, the described systems. Accordingly, other implementations are within the scope of the following claims.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method of processing an electronic sales order process, the method comprising:
receiving, in an electronic sales order process, information that identifies an entity liable for making payment for the sales order and for which a database record exists in an accessible database of entities;
accessing a determined credit rating measure associated with the database record for the entity liable for making payment, to identify a subsequent sales order processing step that has been associated with the determined credit rating measure; and
performing the identified subsequent processing step.

2. The computer-implemented method of claim 1, wherein the database record for the entity has an assigned profile that defines a valuation procedure to be used in determining the credit rating measure.

3. The computer-implemented method of claim 2, wherein the assigned profile further defines multiple different credit ratings.

4. The computer-implemented method of claim 3, wherein the determined credit rating measure is one of the multiple different credit ratings.

5. The computer-implemented method of claim 1, wherein the identified subsequent processing step is a user notification of uncreditworthiness.

6. The computer-implemented method of claim 1, wherein the determined credit rating measure identifies a subsequent processing step intended to receive additional assurance that the entity will make payment.

7. The computer-implemented method of claim 1, wherein the credit rating measure is determined during the course of the sales order process.

8. The computer-implemented method of claim 1, wherein the credit rating measure is determined before receipt of the electronic sales order process.

9. The computer-implemented method of claim 1, wherein the determined credit rating measure has an associated status flag that prompts the identified subsequent processing step to be performed.

10. The computer-implemented method of claim 1, wherein the identified subsequent processing step is a determination of whether executing the sales order would cause a limit in credit balance defined for the entity to be exceeded.

11. A computer program product comprising executable program instructions that when executed by a processor cause operations to be performed comprising:
receiving, in an electronic sales order process, information that identifies an entity liable for making payment for the sales order and for which a database record exists in an accessible database of entities;
accessing a determined credit rating measure associated with the database record for the entity liable for making payment, to identify a subsequent sales order processing step that has been associated with the determined credit rating measure; and
performing the identified subsequent processing step.

12. The computer program product of claim 11, wherein the database record for the entity has an assigned profile that defines a valuation procedure to be used in determining the credit rating measure.

13. The computer program product of claim 12, wherein the assigned profile further defines multiple different credit ratings, and the determined credit rating measure is one of the multiple different credit ratings.

14. The computer program product of claim 11, wherein the identified subsequent processing step is a user notification of uncreditworthiness.

15. The computer program product of claim 11, wherein the credit rating measure is determined during the course of the sales order process.

16. The computer program product of claim 11, wherein the credit rating measure is determined before receipt of the electronic sales order process.

17. The computer program product of claim 11, wherein the determined credit rating measure has an associated status flag that prompts the identified subsequent processing step to be performed.

18. An electronic sales order processing system comprising:
a sales order processing module that receives electronic sales orders that each identify an entity liable for making for making payment for the sales order;
a database of records for entities identified in electronic sales orders, each entity record having an attribute that defines a determined one of multiple credit rating measures for the entity and having at least one defined subsequent processing step associated with at least one of the multiple credit rating measures; and
a credit rating check module that accesses the attribute that defines the one of multiple credit measures determined for the entity to determine subsequent processing performed by the sales order processing module.

19. The system of claim 18, wherein the database uses entity profiles that defines a valuation procedure to be used in determining a credit rating measure.

20. The system of claim 18, wherein the profiles are assignable to entity records so that an entity record has an assigned profile.
